(19) United States
(12) Patent Application Publication
(10) Pub. No.: US 2013/0052080 A1
(43) Pub. Date: Feb. 28, 2013

(54) AUTOMATIC ANALYZER

(71) Applicant: Hidetsugu Tanoue, Hitachinaka (JP)

(72) Inventor: Hidetsugu Tanoue, Hitachinaka (JP)

(73) Assignee: HITACHI HIGH-TECHNOLOGIES CORPORATION, Tokyo (JP)

(21) Appl. No.: 13/643,189

(22) PCT Filed: Apr. 25, 2011
(86) PCT No.: PCT/JP2011/060011

§ 371 Date: Nov. 15, 2012

(30) Foreign Application Priority Data
Apr. 27, 2010 (JP) 2010-101799

(51) Int. Cl. G01N 21/76

(52) U.S. Cl. 422/52

(57) ABSTRACT

The automatic analyzer detects a trace amount of reaction solution at a high S/N with stability. The analyzer allows a photomultiplier to detect light from the reaction solution containing a luminescent substance through an optical window. To process the output from the photomultiplier to analyze the amount of the luminescent substance contained in the reaction solution, an optical transmission system is interposed between the optical window and the photomultiplier. The optical transmission system includes a light inlet opposed to the optical window; a light outlet opposed to the light-receiving surface of the detector; and a reflector on which an incident beam of light from the light inlet is reflected to propagate to the light outlet. This configuration allows the effects of temperature-dependent noise from a flow cell to be reduced while preventing a drop in the amount of light from the luminescent substance, thereby implementing analysis at a high S/N.

### TECHNICAL FIELD

The present invention relates to an automatic analyzer for qualitative and quantitative measurement of a biological sample such as blood or urine.

### BACKGROUND ART

The automatic analyzer is used to measure the concentration of a target component in a biological sample such as blood or urine or to check the presence or absence of the target component. It has higher analysis speed and accuracy compared to manual measurement performed by a laboratory technician, so is becoming popular around major hospitals and testing centers. In particular, when the target component such as a thyroid-associated or infection-associated substance exists at a low concentration in the sample, the analysis requires detecting a faint ray at a high S/N (signal-to-noise ratio).

As a technology to allow such highly-sensitive analysis, for example, the Non-patent Document 1 listed below has been known in public. In this Non-patent document 1, a sample to be analyzed is introduced into a temperature-controlled flow cell (hereinafter, referred to as a cell) and induced to emit light. The emitted light from the sample is received by a photomultiplier as a photo detector through cell window glass (an optical window) to be converted to an electrical current signal; in this way, extremely faint light from a trace amount of the sample is detected by the detector. At this time, the detector is surrounded by a cooler and cooled to reduce noise, thereby achieving high S/N analysis.

In addition, the automatic analyzers have a recent trend of reducing consumption of a reaction solution introduced into the flow cell to reduce testing cost; such a trend requires a high S/N analysis technology capable of reducing the reaction solution consumption.

### LIST OF DOCUMENT(S) AS TO PRIOR ART

### Non Patent Document

Non Patent Document 1: Osawa Zenjiro, Chemiluminescence Kagaku Hakkou no Kiso-Ouyo Jirei (The basics of chemiluminescence and its application in case examples), 4.1 Chemiluminescence Sokutei no Genri to Souchi (The principle of chemiluminescence measurement and apparatuses for the measurement), Maruzen Co. Ltd., published on Dec. 30, 2003

### Summary of Invention

### Technical Problem

In the above non-patent Document 1, the detector is surrounded by the cooler to be cooled for noise reduction; however, this makes the detector to be distanced from the optical window, causing not enough light being collected from a trace amount of light emission.

Consequently, the optical window may be made thinner to bring the detector closer to the window so that light can be prevented from leaking and decreasing to maintain a high S/N. However, when the detector is close to the flow cell, it has an influence of temperature of the flow cell, showing increased noise caused by heat. Since the flow cell is controlled to a specific temperature for stable analysis, the heat-caused noise can be reduced except for a trace amount of light emission. However, in the case of a trace amount of light emission, even if controlling to the specific temperature, an influence of the temperature from the flow cell is unavoidable, it is difficult to make high S/N analysis.

The present invention is an automatic analyzer for detecting and analyzing light emissions from a reaction solution containing a luminescent substance, and its object is to provide the automatic analyzer capable of enhancing sensitivity of a photo detector in detecting light emitted from the luminescent substance and, furthermore, reducing an influence of the temperature of the flow cell exerted on the detector to achieve stable high-S/N detection even for a trace amount of reaction solution.

### Solution to Problem

The present invention relates to an automatic analyzer configured to detect light emitted from a reaction solution containing a luminescent substance through an optical window using a photo detector, processing the output from the photo detector, and analyzing the amount of the luminescent substance contained in the reaction solution; wherein the automatic analyzer is characterized by comprising an optical transmission system provided between the optical window and the photo detector to achieve the above object, and the optical transmission system including a light inlet facing the optical window, a light outlet facing a light-receiving surface of the photo detector, and a reflector configured to reflect light entered through the light inlet and directing the reflected light to the light outlet, so that the optical transmission system prevents a decrease in the amount of light from the luminescent substance, and achieves light detection and analysis without much influence from the temperature of the flow cell.

In addition, the following embodiments disclose features for achieving the object further effectively, which will be described in the embodiments.

### Advantages of Invention

According to the present invention, the automatic analyzer has high-sensitivity and high-stability, which allows high S/N analysis of even a trace amount of a luminescent substance and improves reliability and usability of the automatic analyzer.

### BRIEF DESCRIPTION OF DRAWINGS

FIG. 1 illustrates a configuration of an automatic analyzer according to a first embodiment of the present invention.

FIG. 2 illustrates a cross-section of an optical transmission system used in the first embodiment.

FIG. 3 illustrates a relationship between mediums and an optical path.

FIG. 4 illustrates an optical path used in the first embodiment.

FIG. 5 illustrates a change in signal quantities in the first embodiment.

FIG. 6 illustrates an influence of temperature in the first embodiment.

FIG. 7 illustrates a configuration of an automatic analyzer according to a second embodiment of the present invention.

FIG. 8 illustrates a cross-section of an optical transmission system used in the second embodiment.

### DESCRIPTION OF EMBODIMENTS

Embodiments of the present invention will be described below with reference to examples shown. In the examples, a cylindrical configuration is described as an example of an optical transmission system transmitting light from an optical window to a photo detector. However, its shape is not limited to the cylindrical configuration as long as a reflector is formed on an optical path.

### Embodiment 1

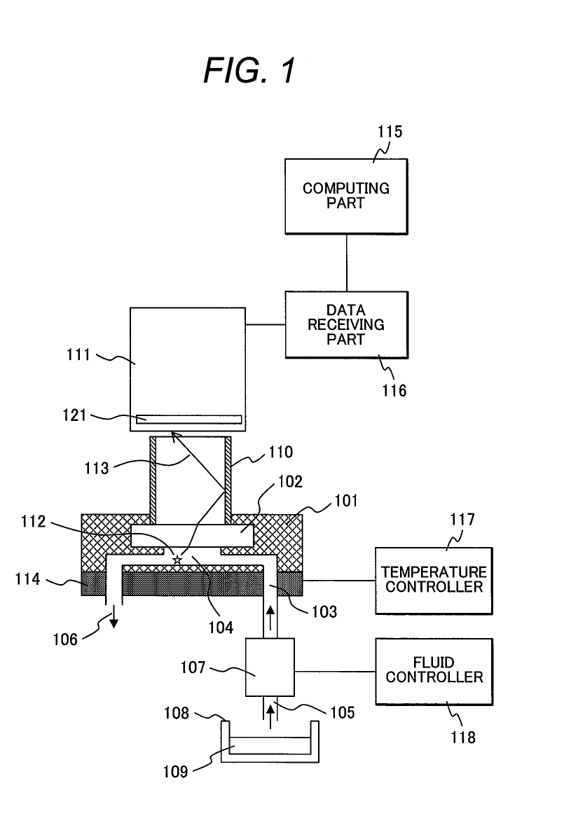

FIG. 1 shows a configuration of an automatic analyzer according to a first embodiment of the present invention. A flow cell 101 is comprised of a flow passage 103 and an optical window 102. A reaction solution 109 containing a luminescent substance in a container 108 is sucked through an inlet 105 into the flow passage 103 by a pump 107 controlled by a fluid controller 118, and introduced to a photometric portion 104 constituting a part of the flow passage 103.

The optical window 102 may be quartz glass, transparent resin, or any other material as long as it can transmit an emission wavelength of a fluorescent substance 112 as a luminescent substance and is approximately 2 to 5 mm in thickness which gives adequate strength to resist against internal pressure of the flow passage 103. A temperature controller 117 controls a heater 114 to keep the reaction solution at a certain temperature in the photometric portion 104. For the heater 114, a Peltier device or any other device may be used as long as it can generate or absorb heat. The light emission of the reaction solution may be started by mixing a reagent or by other conditions. In either case, the reaction solution is introduced into the photometric portion 104 through the flow passage 103 by the fluid controller 118 so as to allow fluorescence to be emitted in proportion to the concentration of the target substance in the photometric portion 104 within the timeframe between the start and the end of the emission.

A ray 113 emitted from the fluorescent substance 112 in the reaction solution introduced into the photometric portion 104 is transmitted through the flow passage 103 and the optical window 102, reflected at the inner surface of an optical transmission system 110, and propagated to a photo multiplier 111, where the light is converted to an electric signal in a light-sensitive surface 121. In place of the photomultiplier 111, a device for converting light into an electric signal such as a photodiode (PD) may be used.

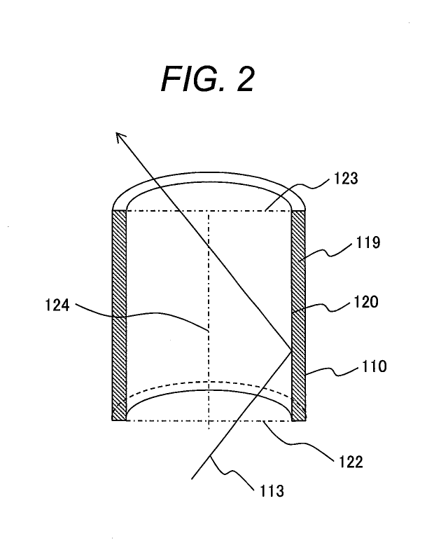

FIG. 2 illustrates a cross-section of the optical transmission system 110 according to the first embodiment. The optical transmission system 110 has a hollow cylindrical shape in the present embodiment, and its inner surface 120 is a reflector which reflects the ray 113 entered from a light inlet 122 to let it exit from a light outlet 123 on the opposite side. The ray 113 exited is received by the photomultiplier 111 facing the outlet. For an illustrative purpose, the reflector is made on the inner surface of the optical transmission system but it may be on the outer surface thereof.

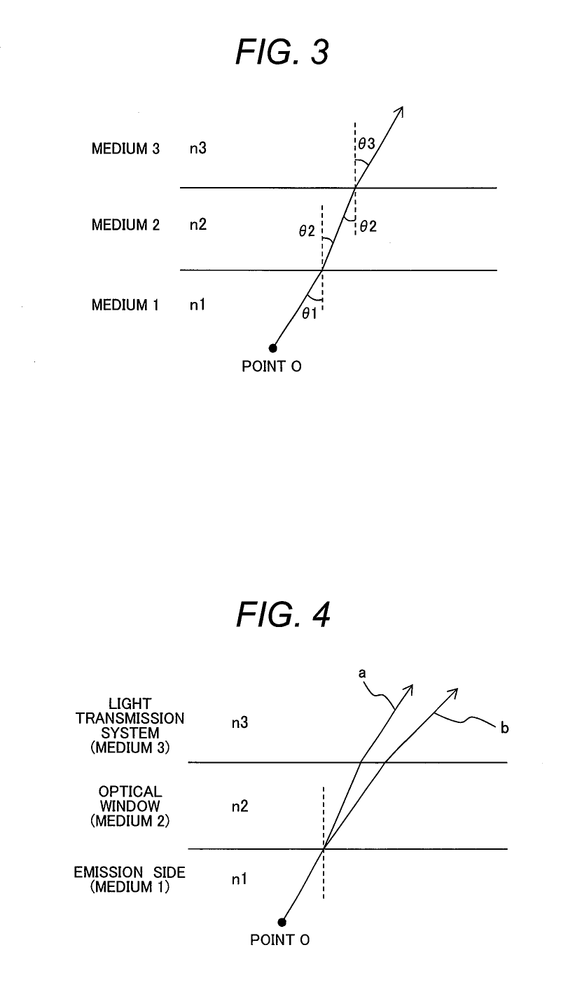

Next, an optical path of the light propagating from the reaction solution in the flow cell to the optical transmission system through the optical window will be discussed. As shown in FIG. 3, provided that a ray of light is emitted from an origin at a given point (point O) in a medium 1 (refractive index n1), transmitted through a medium 2 (refractive index n2), and exited to a medium 3 (refractive index n3), the following equation is true by the Snell's law. (For simplified illustration, the ray of light is shown in a two-dimensional plane, and each of the inner angles θ1, θ2, θ3 is an angle of incident of the ray with respect to the normal of the medium boundary plane.)

n1*sin θ1=n2*sin θ2 (1)

n2*sin θ2=n3*sin θ3 (1)

When the emission side is air, the optical window is glass, and the optical transmission system is air, a ray entering from the point O into the optical window at an angle θ1=30° has angles θ2 and θ3 as shown in Table 1.

TABLE 1

| | | | Normal | |
|---|---|---|---|---|
| | Medium | Refractive | incidence | Angle |
| Medium | name | index | angle | [°] |
| Medium 1 | Emission side | 1 | θ1 | 30 |
| | (air) | | | |
| Medium 2 | Optical window | 1.5 | θ2 | 19 |
| | (glass) | | | |
| Medium 3 | Light transmission | 1 | θ3 | 30 |
| | assembly | | | |
| | (air) | | | |

In the present embodiment, however, a reaction solution is introduced into the flow cell, so the medium 1 in the emission side has a refractive index of 1.3 corresponding to water; thus θ2 and θ3 have the following angles in Table 2.

TABLE 2

| | | | Normal | |
|---|---|---|---|---|
| | Medium | Refractive | incidence | Angle |
| Medium | name | index | Angle | [°] |
| Medium 1 | Emission side | 1.3 | θ1 | 30 |
| | (water) | | | |
| Medium 2 | Optical window | 1.5 | θ2 | 26 |
| | (glass) | | | |
| Medium 3 | Light | 1 | θ3 | 41 |
| | transmission | | | |
| | assembly | | | |
| | (air) | | | |

A relationship of these data is shown in FIG. 4. Line a is an optical path when the emission side is air and Line b is an optical path when it is the reaction solution (corresponding to water) according to the present embodiment. As shown in the figure, when the rays of light from the origin travel to the same direction, the light in the flow cell in which the emission side is the reaction solution is easier to turn outward from the central axis compared to when the emission side is gas, that is, the former condition is easier to dissipate light. Therefore, in the present embodiment, as shown in FIG. 1, the light inlet 122 of the optical transmission system 110 is put in contact with the optical window 102 to transmit the light from the reaction solution without dissipation.

On the other hand, a light-receiving portion of the photomultiplier 111 is made larger than the light outlet 123 of the optical transmission system 110 to receive even a ray exited at a low angle, thereby preventing the dissipation of light. For example, when the optical transmission system 110 is a hollow cylindrical configuration with an outer diameter of about 14 mm and an inner diameter of about 13 mm, the receiving surface of the photomultiplier is about 20 mm in diameter. A mirror base material 119 can be glass, metal, acrylic, resin, or any other material as long as it can maintain the reflector 120 smooth and stable. The reflector 120 can be made of highly reflective material such as sputtered metal ions (Al, Au, etc.) or plating (a refractive index of about 85%) or a reflective film (about a few hundred microns, a refractive index of at least 95%).

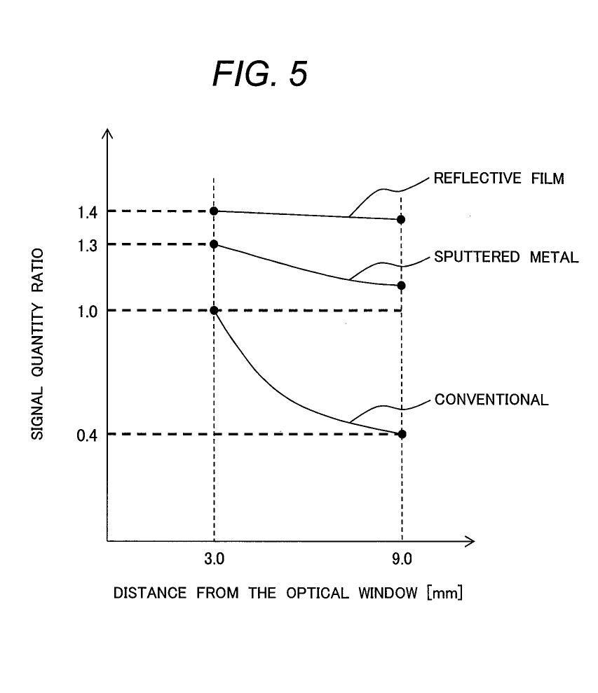

FIG. 5 is a graph illustrating a change in signal quantities in the present embodiment on the basis of a distance of 3.0 mm from the optical window 102 to the photomultiplier 111 (a signal quantity ratio of 1), illustrating a change in signal quantities when the photomultiplier 111 is moved away from the optical window 102. In the present embodiment, the light inlet 122 of the optical transmission system is in contact with the optical window 102, so that no light dissipates within a distance of 3.0 mm; furthermore, when the photomultiplier 111 is moved away, the reflector formed by a reflective film or sputtered metal according to the present embodiment can increase the signal quantity while in the conventional example, the signal quantity decreases to 40%.

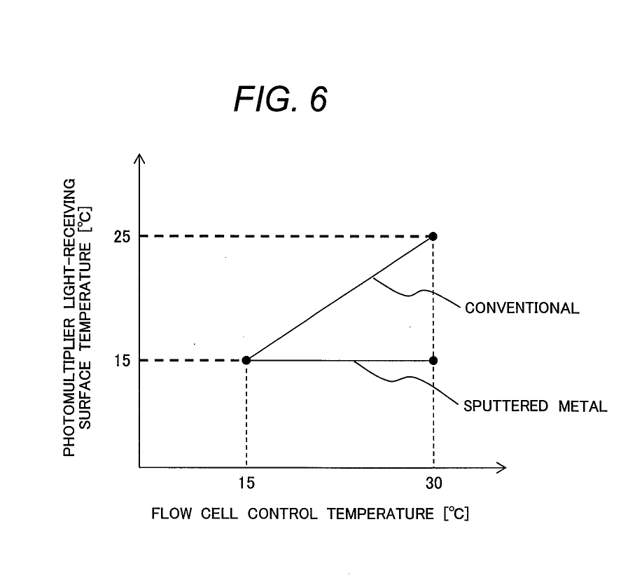

FIG. 6 illustrates a relationship between the control temperature of the photometric portion 104 of the flow cell 101 and the temperature of the light-sensitive surface 121 of the photomultiplier 111 when the inner surface 120 of the optical transmission system 110 is coated with sputtered metal ions and the photomultiplier 111 is located at 9.0 mm. Conventionally, the temperature of the photomultiplier has shown an increase along with the control temperature of the flow cell, but in the present embodiment, the temperature of the photomultiplier shows almost no change. Thus, according to the present embodiment, the heat insulation between the photomultiplier 111 and the optical window 112 is increased, which can prevent an increase or a change in temperature-caused noise in the photomultiplier 111.

### Example 2

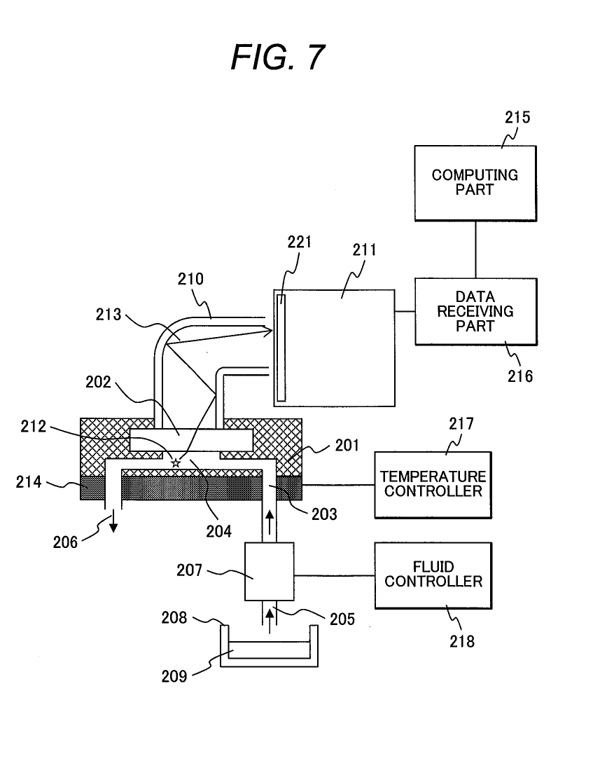

FIG. 7 illustrates a second embodiment of the present invention. A flow cell 201 is comprised of a flow passage 203 and an optical window 202. A reaction solution 209 containing a luminescent substance in a container 208 is sucked through a fluid inlet 205 into the flow passage 203 by a pump 207 controlled by a fluid controller 218, and introduced to a photometric portion 204 constituting a part of the flow passage 203. The optical window 202 may be quartz glass, transparent resin, or any other material as long as it can transmit the emission wavelength of a fluorescent substance 212 as the luminescent substance and is approximately 2 to 5 mm in thickness which gives the strength to resist against the internal pressure of the flow passage 203. A temperature controller 217 controls a heater 214 to keep the reaction solution at a certain temperature in the photometric portion 204. For the heater 214, a Peltier device or any other device may be used as long as it can generate or absorb heat.

The light emission of the reaction solution may be started by mixing a reagent or applying voltage, and in either case, the reaction solution is introduced to the photometric portion through the flow passage 203 by the fluid controller 218 to allow fluorescence to be emitted in proportion to the concentration of the target substance in the photometric portion 204 within the timeframe between the start and the end of the emission. A ray 213 emitted from the fluorescent substance 212 in the reaction solution is transmitted through the flow passage 203 and the optical window 202, reflected by the surface of an optical transmission system 210, and propagated to a photomultiplier 211, where the light is converted to an electric signal in a light-sensitive surface 221 of the photomultiplier. The photomultiplier 211 is a photo detector for converting light to electrons and multiplying them. Many photomultipliers have a long cylindrical structure, which makes the photomultiplier 211 to protrude in a direction perpendicular to the flow cell. For this reason, a central axis of the optical transmission system 210 is curved to make central axes of the light inlet and the light outlet face different directions, thereby reducing the overall size of the system. The angle between the axes is preferably within 90 degrees.

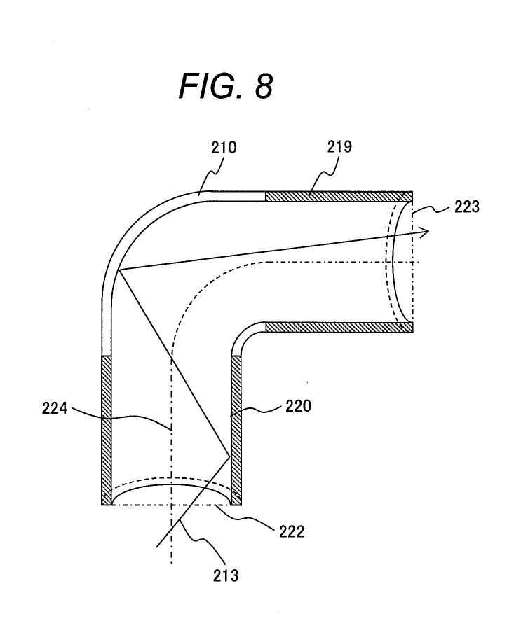

FIG. 8 illustrates a cross-section of the optical transmission system 210 according to the second embodiment. The optical transmission system 210 has a hollow configuration, and its inner surface 220 is a reflector which reflects the ray 213 entered from a light inlet 222 to let it exit from a light outlet 223 on the opposite side. For an illustrative purpose, the reflector is made on the inner surface 220 but it may be on the outer surface of the optical transmission system 210. The ray 213 exited is received by the photomultiplier 211 facing the outlet.

In the same manner as the first embodiment, the optical window and the light inlet 222 are disposed in contact with each other to prevent light dissipation, and a light-receiving portion of the photomultiplier 211 is made larger than the light outlet 223 so as to receive even a ray exited at a low angle.

A mirror base material 219 can be glass, metal, acrylic, resin, or any other material as long as it can maintain the reflector 220 smooth and stable. The reflector 220 can be made of highly reflective material such as sputtered metal ions (Al, Au, etc.) or plating (a refractive index of about 85%) or a reflective film (about a few hundred microns, a refractive index of at least 95%). When it is difficult to form a curved surface with a reflective film, the optical transmission system 210 may be divided into a plurality of parts by bent portions and manufactured separately.

As described above, according to the present embodiment, a central axis 224 of the optical transmission system 210 can be curved, so that the automatic analyzer can be downsized according to its system structure; in this case also, a trace amount of reaction solution can be analyzed at a high S/N without sacrificing high sensitivity and high stability.

### REFERENCE SIGNS LIST

101, 201 . . . flow cell, 102, 202 . . . optical window, 103, 203 . . . flow passage, 104, 201 . . . photometric portion, 105, 205 . . . fluid inlet, 106, 206 . . . fluid outlet, 107, 207 . . . pump, 108, 208 . . . container, 109, 209 . . . reaction solution, 110, 210 . . . optical transmission system, 111, 211 . . . photomultiplier, 112, 212 . . . fluorescent substance, 113, 213 . . . ray, 114, 214 . . . heater, 119, 219 mirror base material, 120, 220 . . . reflector (inner surface), 122, 222 . . . light inlet, 123, 223 . . . light outlet, 124, 224 . . . central axis of the optical transmission system

1. An automatic analyzer for analyzing an amount of a luminescent substance contained in a reaction solution by processing data from a photo detector, comprising: a flow passage for feeding the reaction solution containing the luminescent substance, a temperature controller for controlling flow passage temperature, an optical window for allowing light from the luminescent substance to be emitted outside the flow passage, and the photo detector for detecting the light from the optical window, wherein the analyzer is provided with an optical transmission system including a light inlet facing the optical window, a light outlet facing a light-receiving surface of the detector, and a reflector for reflecting the light entered from the light inlet and propagating the light to the light outlet.

2. The automatic analyzer according to claim 1, wherein the light-receiving surface of the photo detector is larger than the light outlet facing the light-receiving surface.

3. The automatic analyzer according to claim 1, wherein the optical window and the light inlet are in contact and facing with each other.

4. The automatic analyzer according to claim 1, wherein a central axis of the reflector, a central axis of the light inlet, and a central axis of the light outlet of the optical transmission system are connected in a linear line.

5. The automatic analyzer according to claim 1, wherein a central axis of the reflector, a central axis of the light inlet, and a central axis of the light outlet of the optical transmission system are connected in a curved line.

6. The automatic analyzer according to claim 2, wherein the optical window and the light inlet are in contact and facing with each other.
